(19) United States
(12) Patent Application Publication
(10) Pub. No.: US 2013/0071613 A1
(43) Pub. Date: Mar. 21, 2013

(54) SMALL DIMENSION PACKING MATERIAL

(71) Applicant: FoldedPak, Inc., Denver, CO (US)

(72) Inventors: Jeff Boothman, Powell, OH (US); Brad Fehn, Littleton, CO (US)

(73) Assignee: FOLDEDPAK, INC., Denver, CO (US)

(21) Appl. No.: 13/622,874

(22) Filed: Sep. 19, 2012

Related U.S. Application Data
(60) Provisional application No. 61/536,427, filed on Sep. 19, 2011.
(60) Provisional application No. 61/536,430, filed on Sep. 19, 2011.

(51) Int. Cl. B32B 3/24

(52) U.S. Cl. 428/131

(57) ABSTRACT

A packing chip is formed from a flat intermediate sheet and includes a central section and two outer sections located on opposite sides of the central section and a tab located on each of the two outer sections. Each section defines a width and a depth, which may each be between about 0.5 inches and about 0.75 inches. Securing elements for securing the tabs of the chips in an assembled shape are located on each tab. One or more apertures defined by at least one section are configured such that the packing chip forms interlocking engagement with portions of adjacent packing chips when employed as packaging.

### CROSS-REFERENCE TO RELATED APPLICATIONS

This application claims priority to and the benefit of U.S. Provisional Patent Application No. 61/536,427, filed Sep. 19, 2011, entitled “Small Dimension Packing Material,” and U.S. Provisional Patent Application No. 61/536,430, filed Sep. 19, 2011, entitled “Thin-Media Packing Material,” the disclosures of which are hereby incorporated by reference herein in their entireties.

### INTRODUCTION

Paper packing elements are used to protect items during shipment from, for example, on-line retailers or manufacturers to consumer or third-party retailers. Paper packing elements are often desirable over expanded foam packing materials (commonly referred to as “packing peanuts”), or air-filled plastic bladders for a number of reasons. First, paper materials are recyclable. In addition, prior to being used as packing materials, the paper precursors used to make the packing elements may be stored flat, taking up less space in a facility. Other reasons are or would be known to a person of skill in the art. One type of paper packing element is disclosed in U.S. Pat. No. 6,835,437, the disclosure of which is hereby incorporated by reference herein in its entirety.

### SUMMARY

In one aspect, the technology relates to a packing chip formed from a flat intermediate sheet, the chip including: a central section and two outer sections located on opposite sides of the central section and a tab located on each of the two outer sections, wherein each section defines a width and a depth, wherein each of the depth and the width are between about 0.5 inches and about 0.75 inches; a securing element for securing the tabs of the chip in an assembled shape; and one or more apertures defined by at least one section configured such that the packing chip forms interlocking engagement with portions of adjacent packing chips when employed as packaging. In an embodiment, each of the width and the depth are about 0.5 inches. In another embodiment, each of the outer sections defines a spine projecting therefrom, wherein a height of the assembled shape from a point of the spine to a top of the secured tabs is between about 0.75 inches and about 1.00 inches. In yet another embodiment, the height is about 0.75 inches. In still another embodiment, each of the width and the depth are about 0.5 inches and wherein the height is about 0.75 inches. In other embodiments, the securing element includes a dovetail located on each of the tabs. In some embodiments, a first dovetail on a first of the tabs is folded into an area defined by the second dovetail on a second of the tabs when the chip is in an assembled shape. In embodiments, the securing element is an adhesive.

In another aspect, the technology relates to a packing chip formed from a flat intermediate sheet, the chip including: a central section and two outer sections located on opposite sides of the central section and a tab located on each of the two outer sections, wherein each section defines a width and a depth; a securing element for securing the tabs of the chip in an assembled shape; and one or more apertures defined by at least one section configured such that the packing chip forms interlocking engagement with portions of adjacent packing chips when employed as packaging, wherein the sheet comprises a material having a thickness of less than about 0.013 inches. In an embodiment, the sheet has a thickness of about 0.002 inches to about 0.008 inches. In another embodiment, the sheet has a thickness of about 0.008 inches to about 0.010 inches. In another embodiment, the sheet has a thickness of about 0.008 inches to about 0.014 inches. In other embodiments, the securing element comprises a dovetail located on each of the tabs. In yet another embodiment, a first dovetail on a first of the tabs is folded into an area defined by the second dovetail on second of the tabs when the chip is in an assembled shape. In still another embodiment, the securing element is an adhesive.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a top view of a prior art packing element precursor sheet.

FIGS. 2A and 2B are top views of prior art packing element precursor chips.

FIG. 3 is an enlarged top view of the prior art packing element precursor chip of FIG. 2A.

FIG. 4 is a partial end view of a prior art packing element.

FIG. 5A is a perspective view of a prior art packing element.

FIG. 5B is a perspective view of a packing element.

FIG. 6 is a perspective view of a prior art packing element pair.

FIG. 7A is a side view of a prior art packing element.

FIG. 7B is a side view of a packing element.

FIGS. 8A and 8B are schematic sectional views of an item packed with prior art packing elements and small-dimension packing elements, respectively.

### DETAILED DESCRIPTION

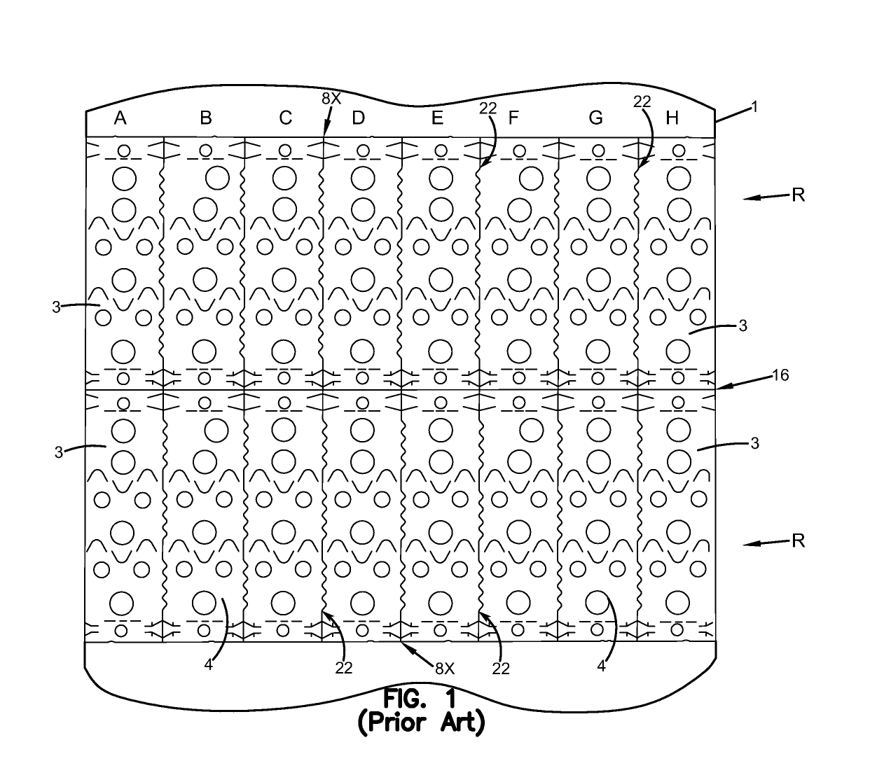

FIG. 1 illustrates the prior art technology in which continuous chipboard sheet 1 is processed into expand-on-site chip intermediates or precursors 3, 4. As illustrated in FIG. 1, sheet 1 comprises eight columns A-H of such chips 3, 4. Only two rows R are depicted, but on a continuous sheet 1, any number of rows may be present. Similarly, the total number of columns may be greater or fewer than eight. One commercial embodiment includes up to 15 columns, although sheets having a greater number of columns also are utilized. Regardless of the number of rows or columns, it is desirable that the chip precursors 3 formed on the sheet of chipboard 1 all remain attached to one another until expanded and separated for use as a packing chip.

Typically, the chipboard sheet 1 is provided from the mill in rolled or fan-folded form. The sheet 1 is unrolled and processed continuously by an intermediate “converter” which has stations to make perforations or lines of weakness for folding or separation, as necessary, and for making holes or other apertures in the chip precursors 3. In addition, the converter may add bonding media, such as adhesive, or connecting features at appropriate places. The sequence in which these steps are performed may be varied depending on the design of the chip precursors 3 and their arrangement on the sheet 1. Machines normally employed in the manufacture of forms or mailers, as well as machines used to make beverage cartons, can be used in the production of the sheet 1 as described herein. All or part of the steps performed by the converter may be performed at the site where the chipboard is made and/or at the site of an intermediate manufacturer. They might also be performed at the site of the ultimate packager, if the volume of chips employed by the packager justifies the capital expense. In the embodiments described herein, all of the structural features of the intermediate are preformed, and the intermediate is delivered to the packager ready for final expansion and separation into individual packaging chips.

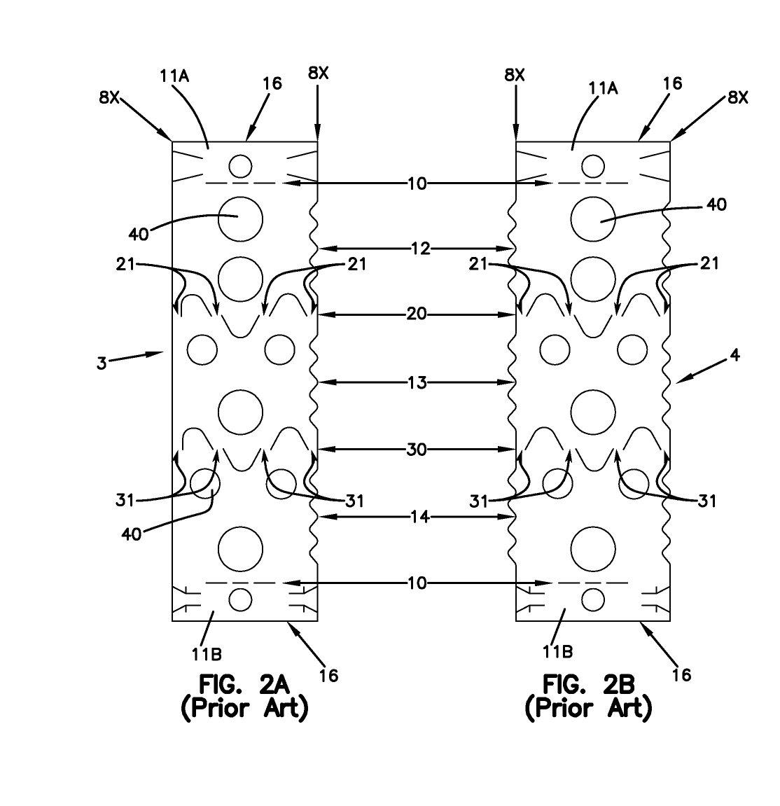

FIG. 2A depicts a prior art chip precursor 3 taken from an outer row of the sheet 1 (i.e., rows A or H), while FIG. 2B depicts a prior art chip 4 taken from an interior row of the sheet precursor 2 (i.e., rows B-G). The chip precursors 3, 4 are similar, except chip precursor 3, like all chips taken from the outer rows A and H, includes one straight edge 8Y, which corresponds to the sheet 1 edge. The other features of both chip precursors 3, 4 taken from outer or inner rows are similar and are described below.

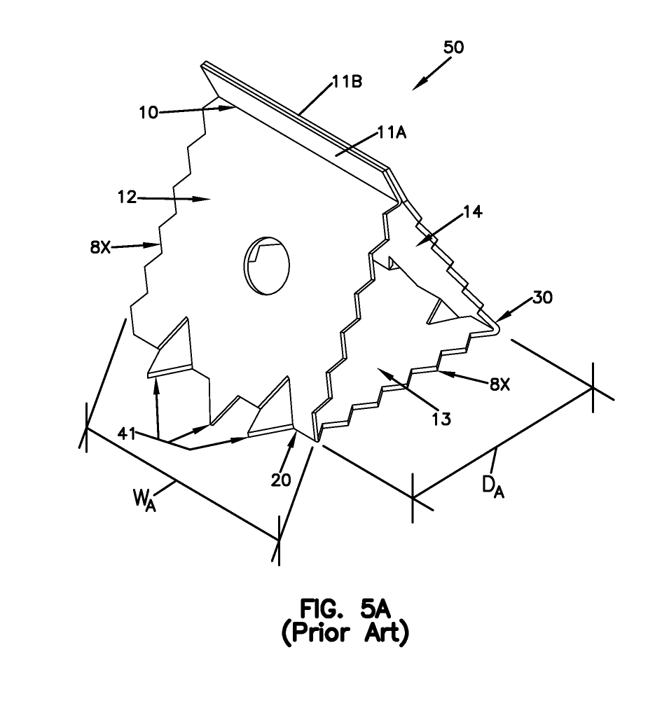

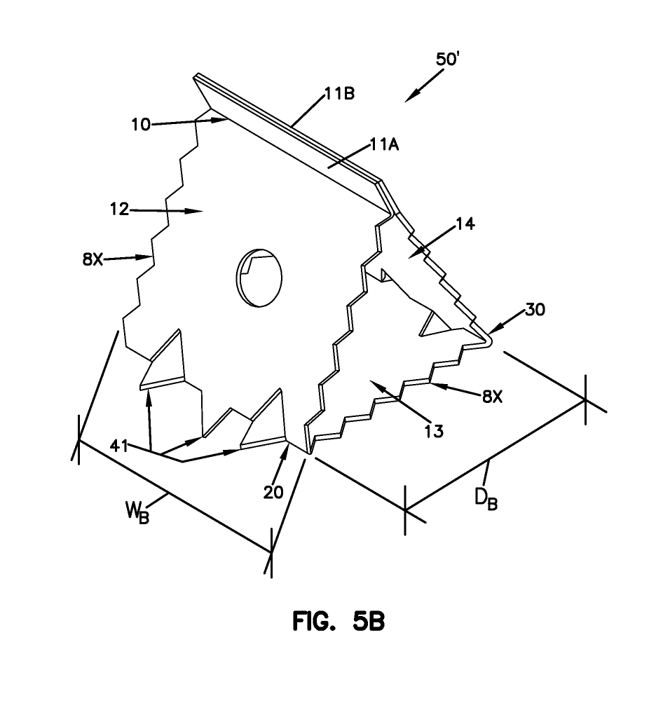

Both chip precursors 3, 4 include sections 12, 13, and 14, which are bounded by jagged fold lines 20 and 30. Fold line 20, for example, is made by the converter with sufficient penetration of the chipboard to facilitate folding and partial separation of sections 12 and 13 during expansion by the expanding machine except at common shoulders 21, where the two adjacent sections are folded but remain attached. This is depicted below in FIG. 5A. Similarly, fold line 30 enables eventual partial separation of sections 13 and 14, except at shoulders 31. In addition, a fold line 10 is formed on one portion of section 12 to form a tab 11A between edge 16 and section 12. A similar tab 11B is separated from section 14 by another fold line 10. Bonding media can be applied to either or both tabs 11A, 11B for securing the expanded chip in its final shape. Alternatively or additionally, the tabs 11A, 11B may be joined by mechanical connections, described below.

As shown in FIG. 1, a converter adds a perforation line 8X between chip precursors 3, 4 to enable them to be completely separated from one another prior to, during or after the expansion step, as necessary. The separation between adjacent chip precursors is accomplished, for example, by bursting or cutting shoulders 22 at the chip interface. As illustrated in that figure, lines 8X are zigzag in configuration, so that the edges formed on the separated and expanded chips will be jagged or serrated, thereby providing appropriate irregular surfaces for interlocking with other fully expanded chips when used as packaging. The lines 8X could be formed in other configurations that would accomplish the same result. Straight edge 8Y on one edge of the outer chip precursors 3 may also be in zigzag in configuration. Still, where the outer edges of the sheets 1 have straight edges, the number of straight edges present in a mass of mixed chips is minimal, thus causing no significant decrease in packing material performance. For example, once the sixteen chips depicted in FIG. 1 are expanded and separated, a total of 28 jagged edges will be present, as compared to four straight edges. The decrease in performance due to these four straight edges is minimal or nonexistent.

The intermediate converter forms a line of weakness 16 between the chip precursors in adjacent rows. The precursor chips in each row may be separated from an adjacent precursor chip by bursting the line of weakness 16. The line 16 may be a straight configuration, as depicted, or may have a zigzag configuration, so that this edge of each chip after separation will be jagged or serrated to aid in interlocking of the expanded chips.

The intermediate converter also adds apertures, such as holes 40, at various locations on each chip precursor. Usually, it is desirable to both cut the aperture and to remove the center portion of the aperture before shipment of the intermediate to the packager. This reduces the shipping weight of sheet 1. Alternatively, the holes 40 can be preformed by the converter, and the center portion removed or just folded in during expansion-on-site. The apertures or holes 40 shown in the figures are circular, but can be any shape, e.g., triangular, square or star shaped in configuration. There may be multiple holes in each section to decrease weight and increase interlocking of the chips. As described later, the holes interlock with jagged or serrated portions or corners on adjacent chips after the chips are applied around a packaged item to be shipped, thereby providing improved blocking, bracing, and cushioning characteristics during shipment.

If bonding material is utilized on either or both of tabs 11A, 11B, it may be a polymer or any suitable adhesive such as thermoset, microwave-activated, ultrasonic-activated, wettable or pressure-activated types that are suitable depending upon the conditions of storage and use. The adhesive can be applied directly to the sheet 1 or supplied in the form of a transfer tape. The adhesive may be selected and/or located so that adjacent segments of sheet 1 will not bond to one another causing “bricking” after the sheet 1 is rolled or fan-folded for shipment to the packager. Technologies for this are well-known to those skilled, for example, in the art of manufacturing mailers and forms with adhesives applied to various portions. Other techniques to avoid bricking include the use of “hot melt” (i.e., thermoset) adhesives. These types of adhesives are relatively easy to activate when desired, do not result in bricking of the sheet 1 when rolled or folded on itself under normal conditions of use, and form a secure bond after curing to maintain the structure of the expanded packing chip. The bonding media may be located on the entire portion of tab 11A, 11B, or on only a portion thereof in a continuous line or in spots in order that the objectives mentioned previously are met while minimizing cost. If a plastic or other synthetic material is used instead of chipboard, adhesive need not be employed. Instead, bonding of the fully expanded chips can be accomplished by the application of pressure and/or heat, ultrasonic energy, solvent, welding, or microwave energy during the assembly of the chips.

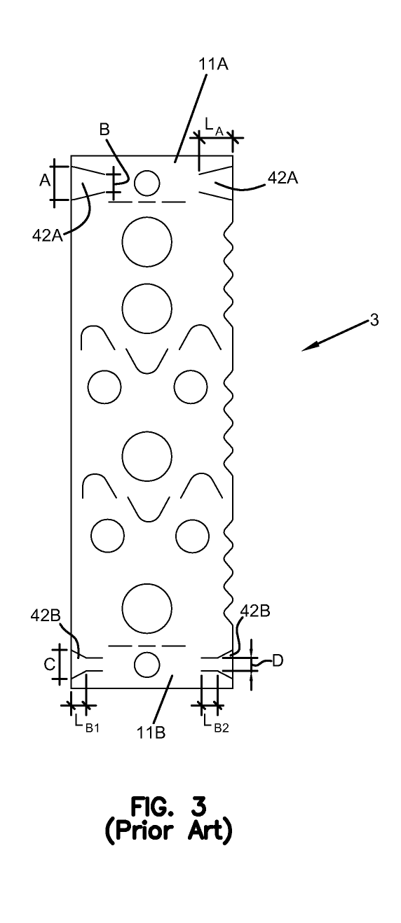

As an alternative to bonding media, the converter may add features to tab 11A, 11B to form connecting features to mechanically hold the fully expanded chip in shape. These connecting features may include: dovetail slots and grooves, tongue and groove cuts, hook cuts, and combinations thereof. These features are “snapped” together to secure the sections of the chips and thereby maintain the chips in their expanded form. Alternatively, attachment methods, such as crimping, stapling, etc., can be utilized after expansion of the precursor to hold the chip in its final shape. One such commercial embodiment is depicted in FIG. 3, where dovetails having different shapes are used to maintain a desired state of assembly. Tab 11A, for example, utilizes two dovetails 42A having a consistent taper from the outer edge of the tab 11A, towards a center of the tab 11A. The dovetail 42A includes both an outside dimension A and an inside dimension B. The outside dimension A, in one embodiment, corresponds generally to a portion of the tab 11A located on an outer edge of the packing chip precursor 3. The inside dimension B, in one embodiment, corresponds generally to a portion of the tab 11A located away from the outer edge of the precursor 3. An appropriate ratio between the inside dimension B and the outside dimension A helps prevent separation of the tab 11A from the tab 11B during use, which helps prevent failure of the chips. It is desirable that the ratio of the inside dimension B of the locking tab to the outside dimension A of the locking tab be within the range of about 1:1.25 to about 1:6. Other ratios may be within the range of about 1.2 to about 1.5. A particularly desirable ratio may be about 1.4. For example, if the inside dimension B of the locking tab is 0.125 in and the outside dimension A of the locking tab is 0.250, the ratio is 0.125:0.250 or 1:2.

Tab 11B, utilizes two dovetails 42B having a consistent taper from the outer edge of the tab 11A, and two substantially parallel edges towards the center of the tab 11A. The dovetail 42B includes both an outside dimension C and an inside dimension D. The outside dimension C, in one embodiment, corresponds generally to a portion of the tab 11A located on an outer edge of the packing chip precursor 3. The inside dimension D, in one embodiment, corresponds generally to a portion of the tab 11B located away from the outside edge of the packing chip precursor 3. An appropriate ratio between the inside dimension D and the outside dimension C helps prevent separation of the tab 11A from the tab 11B during use, which helps prevent failure of the chips. It is desirable that the ratio of the inside dimension of the locking tab to the outside dimension of the locking tab be within the range of about 1:1.25 to about 1:6. Alternative ratios may be within the range of about 1.2 to about 1.5. A particularly desirable ratio may be about 1.4. For example, if the inside dimension D of the locking tab is 0.125 in and the outside dimension C of the locking tab is 0.250, the ratio is 0.125:0.250 or 1:2.

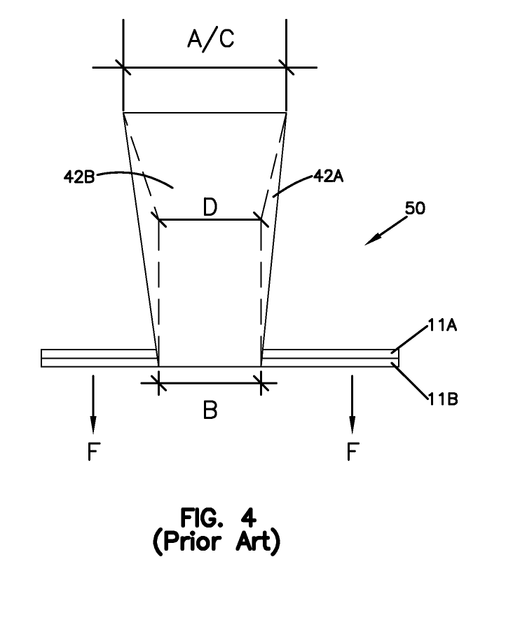

Notably, outer dimensions A and C are similar, as are inner dimensions B and D. The difference in the other dimensions of the dovetails 42A, 42B improves the ability of the dovetails 42A, 42B to stay secured during use. As can be seen in FIG. 3, dovetail 42A has a consistent taper across its entire length L_{A}. Dovetail 42B however, includes a taper along a first portion of its length L_{B1}, followed by a consistent parallel dimension L_{B2}. Thus, when dovetail 42A is deflected into the opening formed by dovetail 42B, inner dimension B of dovetail 42A is fixed securely within the parallel dimension L_{B2} of dovetail 42B. Since dovetail 42A consistently tapers across its entire length L_{A}, any attempted separation of tab 11A from tab 11B will be prevented. This condition is depicted in FIG. 4, which is a partial edge view of an assembled prior art chip element 50. Tabs 11A and 11B are in a mating configuration, and dovetail 42A has been pushed through the opening formed by dovetail 42B (shown hidden). As a force F is applied in an effort to separate tab 11A from tab 11B, the consistent tapered dimension of dovetail 42A immediately causes that dovetail 42A to contact the tab 11B, and thus holding the tabs 11A, 11B together.

After preparation by the converter, sheet 1 may be rolled, stacked or fan-folded and transported to the packager where it is stored in that format until it is ready to be used. When the packager needs packaging material, it unrolls or unfolds the sheet 1 and either manually expands the precursors into finished chips or threads the sheet into the expanding machine to form individual packing chips 50 as illustrated in FIG. 5A. In this embodiment, for clarity, the dovetails 42A, 42B are not depicted and the tabs 11A, 11B are secured with adhesive. Forming the individual packing chips 50 can be accomplished in various ways. In one method, the machine folds along lines 10, 20, and 30 to form the tabs 11A and 11B, as well as sides 12, 13 and 14, into a triangular shape. The folding of lines 20 and 30 forms spines or projections 41 which are also useful for engagement and interlocking of the chips 50 when used in packaging. The spines 41 are formed by partially cutting out the material on bending corners 20 and 30 of the triangular shaped chip, so that it does not bend but protrudes from the section when the chip 50 is expanded by folding. Heat is applied to activate the hot melt adhesive on either of the tabs 11A, 11B. The tabs 11A, 11B are then pressed against each other and clamped during cooling to cure the adhesive bond. Of course, in embodiments that utilize dovetails such as described above, the tabs 11A and 11B may be placed in contact with each other and dovetail 42A deflected through the opening of dovetail 42B.

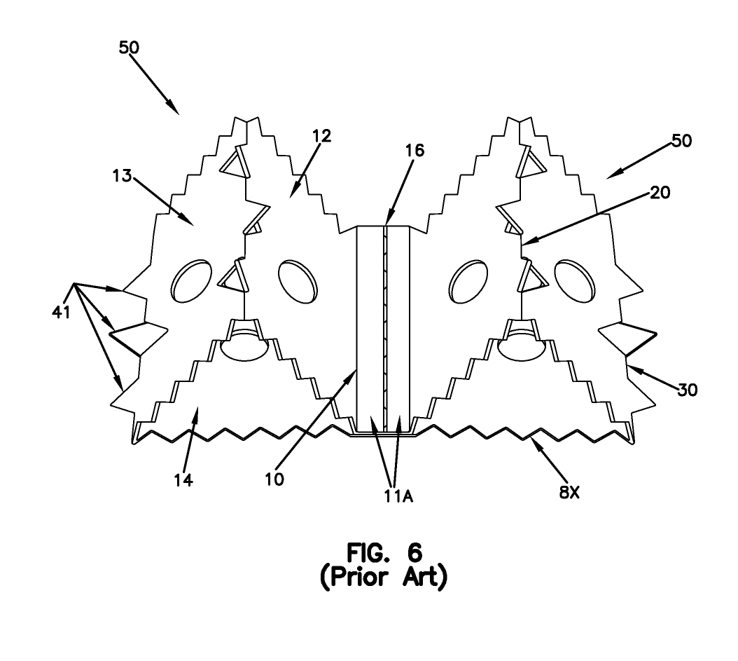

In one embodiment, the assembly of a chip 50 occurs simultaneously with the assembly of another chip 50 in an adjacent row as they remain attached together. FIG. 6 shows two such chips 50 fully formed (i.e., expanded) and bonded. A “bursting” wheel is then used to “burst” the chips 50 along lines 8X depicted above. However, the two chips 50 remain attached to each other along the separation line 16. Another rotary slitter or bursting wheel is then used for final separation of the chips 50 from each other. The fully expanded and secured chip 50 shown in FIG. 5A can then be used as packing material.

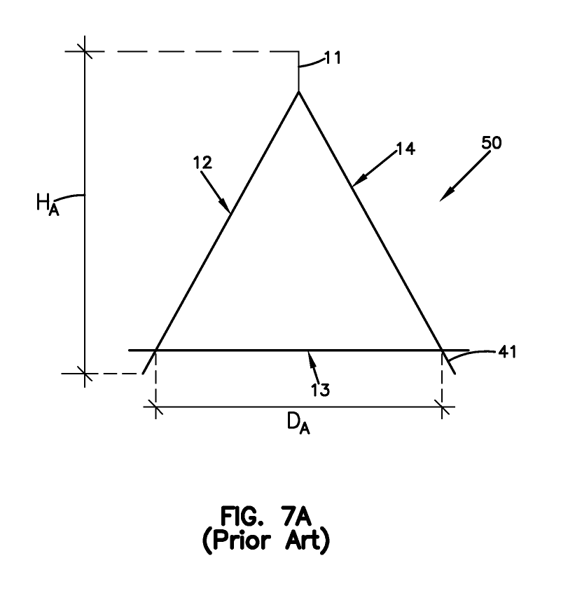

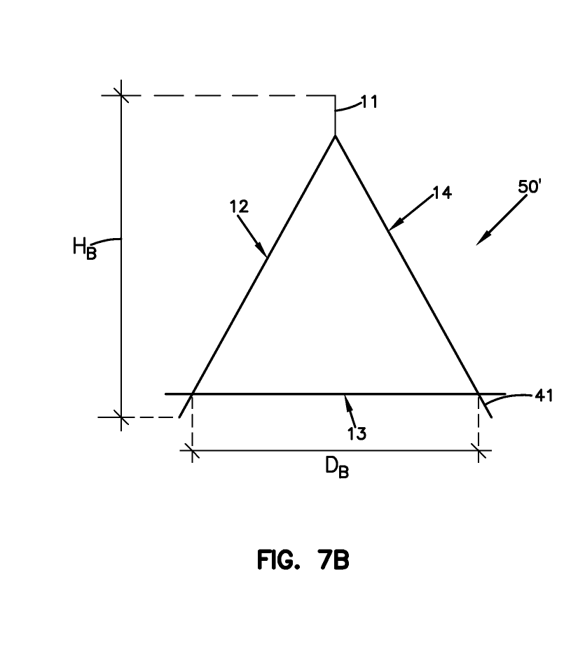

Packing elements manufactured to the above specifications are available from FoldedPak, LLC, of Greenwood Village, Colo. The dimensions of such chips 50, as those dimensions are depicted in FIGS. 5A and 7A, typically are a depth D_{A} of about 1.25 inches, a width W_{A} of about 1.25 inches, and a height H_{A} of about 1.5 inches. Width W_{A} and depth D_{A} also are depicted in FIG. 5A, where width W_{A} is perpendicular to depth D_{A}. Existing packing elements also have a precursor thickness of about 0.015 inches to about 0.024 inches. As depicted, the height H_{A} is measured from the bottom of the projecting spines 41 to the top of the tab 11.

The cushioning performance of this type of expand-on-site packaging is attributable, in part, to its shape and the properties of the material from which it is made. Performance of the completed packing chips 50 is enhanced by engagement of the holes 40, serrated edges 8X, and spines 41 interacting with one another to lock and prevent slippage of the chips 50 relative to one another. This interlocking of the chips 50 also prevents movement of the packaged item within the container.

The surface of commercially available chipboard is relatively smooth and does not create sufficient friction between chips. Simply roughing up the surface would result in exposed paper fibers that would cause dust. Instead, the expand-on-site packaging material has interlocking features (spines, holes and serrated edges) preformed into the surface of each chip. For example, the spines 41 interlock with the serrations, holes, and edges of adjacent chips. The spacing and frequency of these features may be designed to maximize both the likelihood of interlocking adjacent chips and the durability of that interlocking relationship. The combination of these features creates a chip that has excellent blocking and bracing characteristics.

When prepared from chipboard 0.024 inches thick, the expand-on-site packaging material as illustrated in FIG. 5A has an average density of 1.8 pounds per cubic foot. This is lighter than many competitive products and is considered marketable. Heavy-duty expand-on-site packaging material may also be produced by using heavier caliper (i.e., thicker) chipboard for shipment of higher density or heavier packaged items. However, simply making packing chips out of thicker materials to package heavier items involves challenges previously unrecognized in the art. The technology described below identifies and overcomes these challenges. A number of modifications to the structure of the packing chip 50 disclosed above allow a chip manufactured of similar materials to be used to protect heavy items. One such modification includes making the chip with small outer dimensions such that flowability (i.e., during dispensing of the chips) is increased, allowing chips to spread to fill void space around heavy items.

Packing materials are often characterized by their cushioning properties and blocking and bracing properties. The packaging material must provide cushioning for packaged items to protect them during shipment. The packaging material must dissipate or diffuse the shock loads imposed on the packaging container (typically a box or container) during shipment so that those loads are not applied to the packaged item directly. It is also important that the packaging material have high rebound characteristics (within its usable range) so that it can continue to provide cushioning, as loads are repeatedly applied. Different items packed for shipment may require different degrees of stiffness to adequately protect them. The ability of the packaging material to “block and brace” refers to its capability to prevent movement of the packaged item within the container so that the packaging can cushion that item. If a packed item is allowed to move against the wall of the container, with no cushioning in between, then it will be directly subjected to any shock loads applied to the outside of the box adjacent that location.

Flowable packaging materials may be poured and placed into a shipping container quickly. They also do not require wrapping, taping or other labor-intensive operations as with many other packing materials. However, flowables (e.g., loose format packaging materials) often do not provide adequate blocking and bracing characteristics. Plastic peanuts, for example, exhibit good cushioning properties, but have such poor blocking and bracing characteristics that the packaged item moves around in the container or box. When the packaged item reaches a wall of the container, it is no longer protected by the packaging material and is susceptible to being broken when the package receives an external blow. By definition, “flowables” flow easily into the box during packing, but also flow inside the box after packing, allowing movement of the packaged item.

Prior packing materials, while a significant improvement over packing peanuts, still display certain undesirable characteristics when used in conjunction with very heavy packed items. It would logically be expected that thicker precursor materials would display stronger properties than thinner materials. However, simply making the disclosed packing chips out of thicker materials does not solve the problems attendant with packaging heavy items. For example, thicker chipboard precursors are difficult to manufacture due to the inherent difficulty in making chipboard sheets and forming the packing chip elements. Thicker materials, even with the scoring lines and cuts present in the chipboard, are also difficult to separate and fold. Additionally, thicker materials weigh more than thinner materials, on a weight per cubic foot basis. This makes precursors difficult to handle, and more expensive to ship to a packager. Also, thicker materials increase the total weight of the shipped item, thus resulting in higher shipping costs that are generally passed on to the customer.

It has been discovered that packing chips made from standard thickness materials (i.e., as described above as the chip 50 of FIGS. 5A and 7A), but with smaller outer dimensions, may effectively cushion larger items, without having to increase the material thickness, density, etc. Such dimensionally-smaller chips may be distributed around heavy, irregular loads more readily (i.e., they exhibit improved flowability), which allows them to more adequately cushion such items. Surprisingly, the increased flowability around heavy items allows the smaller chips to adequately cushion such items, even though they are manufactured of the same material as larger-dimensioned chips. This has been discovered to be true for precursor materials manufactured to the same thickness as prior art precursors (i.e., about 0.015 inches to about 0.024 inches).

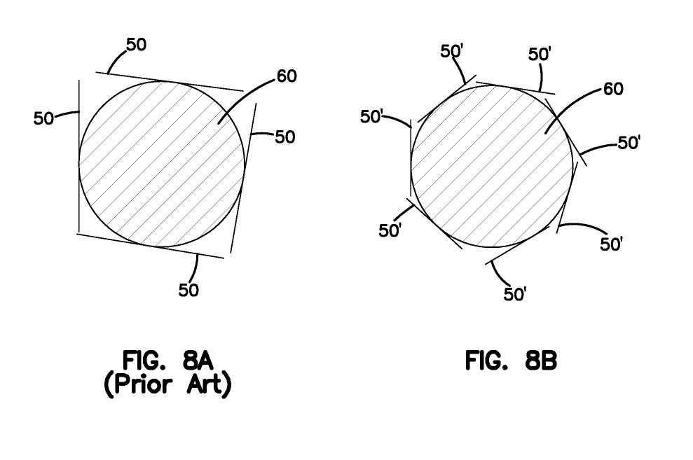

Such an improved chip 50′ is depicted in FIGS. 5B and 7B. The improved chip 50′ includes many of the same structural features of chip 50. Accordingly, those features are not described again here. The improved chip 50′ has a depth D_{B} of about 0.5 inches, a width W_{B} of about 0.5 inches, and a height H_{B} of about 0.75 inches. It has been discovered that precursor material of the thicknesses described above in the prior art chips 50 may effectively be used to manufacture smaller chips 50′, while still being able to cushion heavier items. A comparison of the prior art chips and the improved smaller-dimension chips are depicted in FIGS. 8A and 8B. Other chips having a depth D_{B} of about 0.75 inches, a width W_{B} of about 0.75 inches, and a height H_{B} of about 1.00 inches are also contemplated. Indeed, improvements in chip performance for chips having dimensions of less than the prior art chips have been observed. Increases in chip support on a weight/unit area basis (described in more detail below) have been identified in chips dimensioned smaller than the prior art, as small as chips having a depth D_{B} of about 0.5 inches, a width W_{B} of about 0.5 inches, and a height H_{B} of about 0.75 inches. Even smaller chips are contemplated and it is expected that increases in performance may be further had with even smaller chips.

Both FIGS. 8A and 8B depict sectional views of a heavy item 60 surrounded by packing material 50, 50′. Only a single contacting surface of the packing material 50, 50′ is shown, for clarity. For example, the single contacting surface may be section 12, 13, or 14, or the single contacting surface may be an edge defined by serrated line 8X, as depicted in FIGS. 5A and 5B. Regardless, the principles that allow for improved cushioning are described below, as they relate to FIGS. 8A and 8B. As can be seen, only four packing elements 50 surround the heavy item 60. As the box containing the heavy item 60 and packing elements 50 is moved during shipment, forces applied to the box are transferred and dispersed within the box by the packing elements 50. Similarly, and especially with very heavy, irregularly-shaped items, the force of gravity is constantly acting on the heavy item 60 against the cushioning force of the packing elements 50. As the external and internal forces cause shifts if the load distribution within the box, the packing material 50 acts to cushion and disperse those forces throughout all the material, due to the interlocking edges, projections, holes, etc., described above. As can be seen, since only four cushioning elements 50 are in contact with the heavy item 60, the cushioning properties acting upon the heavy item 60 are limited to the force that may be applied by those four elements 50. It has been determined that the prior art packing material having dimensions of 1.25 inches W_{A}, 1.25 inches D_{A}, and 1.75 inches H_{A} may provide support on a weight/unit area basis of about 0.3 lbs. per square inch.

In stark contrast, however, FIG. 8B depicts a heavy item 60, surrounded by small-dimension packing material 50′, such as the improved packing materials described herein (e.g., in relation to FIGS. 5B and 7B above). As can be seen in even this simplified example, a greater number of surfaces make contact with the heavy item 60, thus helping to ensure that forces are more evenly distributed among the total volume of packing material 50′ within the box. With more complexly-dimensioned items, the advantages of the small-dimension packing materials 50′ become even more apparent. That is, smaller packing materials 50′ flow more easily into interstitial spaces formed in housings, between parts of motors or engines, portions of sculpture, etc. With the higher number of packing elements 50′ distributed more evenly around the heavy item 60, forces are more evenly distributed, thus improving cushioning ability of the packing material 50′. This increase in packing density enables support on a weight/unit area basis of about 0.5 lbs. per square inch, even for packing material having dimensions of only 0.5 inches W_{B}, 0.5 inches D_{B}, and 0.75 inches H_{B}. It should be emphasized that this improvement in performance exists even when the packing elements 50′ are manufactured from identical precursor material, even though one or more of the height H_{B}, depth D_{B}, and width W_{B} (with reference to FIGS. 5B and 7B), are significantly smaller than the height H_{A}, depth D_{A}, and width W_{A} of the prior art packing elements 50 described above.

Manufacturing packing chips with smaller dimensions is but one way to improve the performance of the packing chips described above in FIGS. 5A and 7A. Since the packing chip is made from chipboard to maintain a desired level of structural rigidity, the expense associated with the precursor material may limit the number of packing applications for which the chips may be used. It has been discovered, surprisingly, that a chip having similar outer dimensions to the prior art chips 50 of FIGS. 5A and 7A may be manufactured of thinner material, thus reducing the expense of raw materials, while still maintaining acceptable cushioning properties. Additionally, by reducing the cost associated with precursor materials, the resulting packing chip may be used in a larger number of applications, including as a general purpose non-protective void fill product.

This is not, however, a simple matter of manufacturing packing chips of thinner material. If the packing elements are simply made from thinner material of insufficient stiffness, it is likely that a spine 41 or serration 8X may fail if forced into an opening 40 in an adjacent packing chip, causing the chips to side against each other and dislodge, which reduces the chips' effectiveness as a packing material. Additionally, precursor materials lacking sufficient stiffness (regardless of thickness of material) have been discovered to not expand properly. For example, during the folding process, it has been discovered that certain elements (e.g., spines 41) will not separate from the precursor if the stiffness of the material is insufficient. If the spines do not separate, the cushioning properties and interlocking performance of the packing chip will be compromised. Chips that lack sufficient stiffness are also subject to crushing. It has been discovered that paper material having particular Taber stiffness values in both Machine Direction (MD) and in Cross Direction (CD) may be used effectively to improve overall performance of even thin-media precursor material.

The prior art packing materials described above in FIGS. 5A and 7A are manufactured of paperboard having a thickness of about 0.015 inches to about 0.024 inches. Surprising discoveries have been made, however, that allow packing chips to be manufactured of precursors having even smaller thicknesses. For example, chips having a 0.008 inch thickness with a Taber MD stiffness of 72 and a Taber CD stiffness of 29 have been manufactured to acceptable cushioning standards. Other embodiments include chips having a 0.013 inch thickness with a Taber MD stiffness of 80 and a Taber CD stiffness of 32, as well as chips having a 0.015 inch thickness with a Taber MD stiffness of 110 and a Taber CD stiffness of 45. Precursor materials having other thicknesses but comparable stiffness values are contemplated. In such cases, materials having a thickness of about 0.002 inches to about 0.008 inches are also contemplated, as are thicknesses of about 0.008 inches to about 0.010 inches and thicknesses of about 0.008 inches to about 0.014 inches.

Other thin materials having desirable stiffness qualities but reduced thicknesses have been utilized successfully. For example, a utility grade PVC material has been used. The PVC chip has a thickness of 0.008 inches, and is PVC Type 478/14, available from Klockner Pentaplast. Use of such materials may be especially desirable for use in industrial applications, where parts are shipped between manufacturers. In such cases, plastic chip elements may be reused almost indefinitely by either manufacturer for shipping parts between facilities.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A packing chip formed from a flat intermediate sheet, the chip comprising:
a central section and two outer sections located on opposite sides of the central section and a tab located on each of the two outer sections, wherein each section defines a width and a depth, wherein each of the depth and the width are between about 0.5 inches and about 0.75 inches;
a securing element for securing the tabs of the chip in an assembled shape; and
one or more apertures defined by at least one section configured such that the packing chip forms interlocking engagement with portions of adjacent packing chips when employed as packaging.

2. The packing chip of claim 1, wherein each of the width and the depth are about 0.5 inches.

3. The packing chip of claim 1, wherein each of the outer sections defines a spine projecting therefrom, wherein a height of the assembled shape from a point of the spine to a top of the secured tabs is between about 0.75 inches and about 1.00 inches.

4. The packing chip of claim 3, wherein the height is about 0.75 inches.

5. The packing chip of claim 3, wherein each of the width and the depth are about 0.5 inches and wherein the height is about 0.75 inches.

6. The packing chip of claim 1, wherein the securing element comprises a dovetail located on each of the tabs.

7. The packing chip of claim 6, wherein a first dovetail on a first of the tabs is folded into an area defined by the second dovetail on a second of the tabs when the chip is in an assembled shape.

8. The packing chip of claim 1, wherein the securing element comprises an adhesive.
